(19) United States
(12) Patent Application Publication
(10) Pub. No.: US 2002/0005866 A1
(43) Pub. Date: Jan. 17, 2002

(54) Method and system for creation of a spatially referenced multimedia relational database that can be transmitted among users or published to internet

(75) Inventors: Robert S. Gorham, Champaign, IL (US); Albert D. Hart, Centennial, CO (US); Richard D. Hart, Littleton, CO (US); Robert K. Gorham, Champaign, IL (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: SPACE-WISE TECHNOLOGIES, INC.

(21) Appl. No.: 09/846,978

(22) Filed: May 1, 2001

Related U.S. Application Data
(60) Provisional application No. 60/218,420, filed on Jul. 14, 2000.

(51) Int. Cl. G09G 5/00

(52) U.S. Cl. 345/760

(57) ABSTRACT

A method and system that develops a presentation of an image with a plurality of web pages with capabilities of zoom in, URL linkage, media of various types that present content for one or more parts of the image when selected by an end user. The method enables a developer to create the presentation in an interactive session. Initially, the developer selects a file of an image, which may be any desired image, such as a floor plan of a building, a crime or scene, a map, a landscape, a human, animal, aquatic or other body. The image is stored as a digital background in a project folder. The developer is given the option to provide scaling data and to select one or more spatial parts of the image. The scaling data and the spatial part data is stored in the project folder. The developer can then select one or more elements for placement within one or more areas of the image. For example, furniture elements can be selected from a library of furniture elements for placement in a bedroom of a floor plan image. The developer can then select one or more icons that are representative of various types of media for placement in the areas of the image. An icon is then associated with a content that in the presentation will be presented to the end user upon selection of the icon. For example, a photograph of the bedroom may be associated with a camera icon placed in the bedroom. All of the element, icon and content data is placed in the project folder. HTML script is then written for a variety of browsers that might be used to view the presentation. The HTML script is also placed in the project folder. The project folder then can be used by a server in an online presentation over the Internet or Web or can be used in an offline session with the end user.

### RELATED APPLICATIONS

This application claims the benefit of U.S. provisional application No. 60/218,420, filed Jul. 14, 2000.

### BACKGROUND OF THE INVENTION

1. Field of the Invention

This invention relates to a method and a system that forms a relational database for the presentation of an image. More particularly, the present invention relates to such a method and system in which the presentation of the image is in one or more media of expression with drill down capability to useful information about the image or parts thereof.

2. Description of the Prior Art

Geographical information systems are currently available in which a map image is used in a drill down mode to obtain useful information. For example, a map of the state of Illinois is displayed to a user. The user selects the city of Chicago and a map of Chicago is displayed. The user selects a part or region of Chicago and the region is displayed. The user can then select a sub-region and so on. At each drill down level, useful information can also be displayed. For example, the useful information may be the location within a particular drill down level of hotels, restaurants, gasoline stations, churches, stores, and the like. Geographical information systems are based on a geographical coordinate system that is fixed worldwide. As a result, geographical information systems are limited to applications, such as map imaging and global positioning.

### SUMMARY OF THE INVENTION

An object of the present invention is to provide a system and/or a method that forms a relational database for the presentation of any image.

Another object of the present invention is to provide a system and/or a method that forms a relational database for the presentation of any image in one or more multi-media formats.

These and other objects and advantages are achieved by the present invention that provides a method and system that develops a presentation of an image with a plurality of cascading web pages. One or more elements are registered at selected areas of the image. For example, if the image is a floor plan of a house, furniture elements are registered in a bedroom, a living room, a dining room and the like. One or more icons representing types of media are located in the selected areas. For example, a camera icon is located in the living room. A content is associated with each icon. Thus, a photograph is associated with camera icon. The plurality of cascaded web pages is formed with HTML script that is compatible with a plurality of different types of browsers. When the camera icon, for example, is selected during the presentation, the photograph content is presented.

In a preferred embodiment of the present invention, the elements, icons and content are determined in an interactive session with a developer. The image and the elements are scaled so that a scale of the image is proportionate to a scale of the elements. A library of elements is presented to the developer for selection of desired elements. A library of media icons is also presented to the developer for selection of desired media icons. The developer is also presented with the ability to define areas for a zoom in view or an URL link to a web site.

### BRIEF DESCRIPTION OF THE DRAWING

Other and further objects, advantages and features of the present invention will be understood by reference to the following specification in conjunction with the accompanying drawings, in which like reference characters denote like elements of structure and:

FIG. 1 is a block diagram of a system of the present invention;

FIG. 2 is a block diagram of the computer of the FIG. 1 system;

FIG. 3 depicts a display screen of the imaging program of the computer of FIG. 2;

FIGS. 4 and 5 depict dialog boxes for the FIG. 3 display screen;

FIG. 6 depicts a selection of spatial parts of an image of the FIG. 3 display screen;

FIG. 7 depicts a dialog box for the FIG. 6 display screen;

FIG. 8 depicts another display screen of the imaging program of FIG. 2;

FIGS. 9 through 11 depict drill spatial parts of an image of the FIG. 8 display screen;

FIG. 12 depicts a dialog box for selection of elements for the spatial parts of FIGS. 6 and 9 through 11;

FIG. 13 depicts a dialog box for selection of media icons for the spatial parts of FIGS. 6 and 9 through 11;

FIG. 14 depicts a dialog box for selection of media files for the selected media icons of FIG. 13;

FIG. 15 depicts a dialog box for a file transfer of a web page folder to an Internet service provider; and

FIGS. 16 through 18 are flow diagrams of the imaging program of the FIG. 2 computer.

### DESCRIPTION OF THE INVENTION

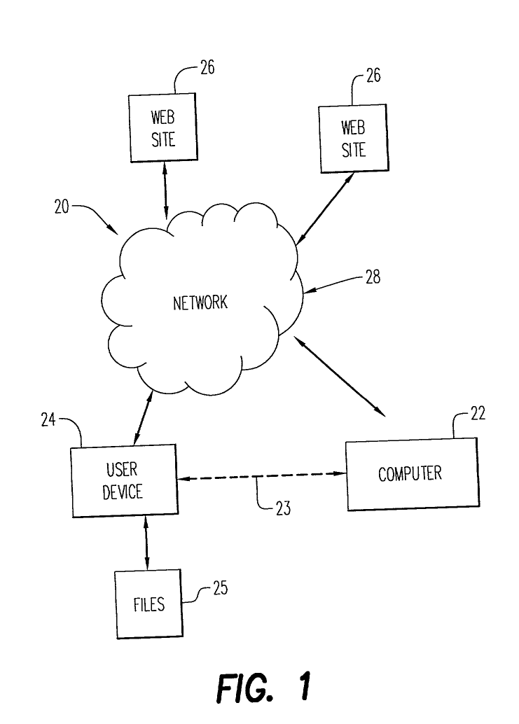

Referring to FIG. 1, a system, designated generally by reference numeral 20, includes a computer 22 that communicates with a user device 24 via a network 28. Also connected to network 28 are a plurality of web sites 26, of which only two are shown. User device 24 may be any suitable device upon which a browser may run, such as a personal computer, a telephone, a television set, a hand held computing device and the like. It will be appreciated by those skilled in the art that the number of user devices and web sites is limited only by the capacity of network 28. Network 28 may be an Internet, a World Wide Web (Web), an Intranet, a wired or wireless telephone network, and the like, or any combination thereof. Alternatively, user device 24 may communicate with computer 22 via an off-line connection shown generally by dashed line 23. User device 24 may optionally have a set of files 25 that contain graphic images.

Computer 22 may be any suitable computer, presently known or developed in the future, that is capable of communicating with user device 24 in a protocol that is compatible with the browser capability of user device 24 and that is capable of running applications that supply web page data and interact with web page actions taken by user device 24. Computer 22 may be a single computer with a memory system for the storage of data or may comprise a plurality of computers that are interconnected directly or via network 28.

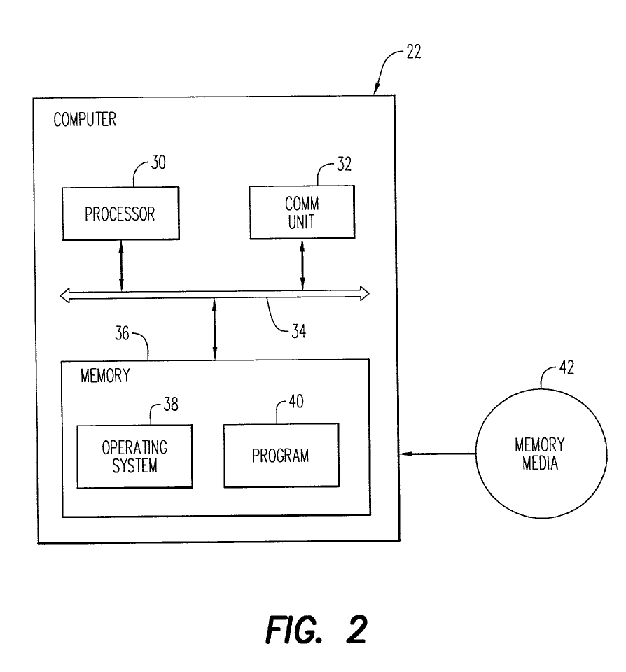

Referring to FIG. 2, computer 22 includes a processor 30, a communications (comm) unit 32 and a memory 36 that are interconnected via a bus 34. Memory 36 includes an operating system 38 and an imaging program 40. Other programs, such as utilities and other applications, may also be stored in memory 36. All of these programs may be loaded into memory 36 from a storage medium, such as a disk 42.

Processor 30 is operable under the control of operating system 38 to execute imaging program 40 to presents one or more screens or web pages to user device 24 for an interactive session and to receive and interact with responses from user device 24. The web pages, if frequently served, may reside in a cache (not shown) of memory 36.

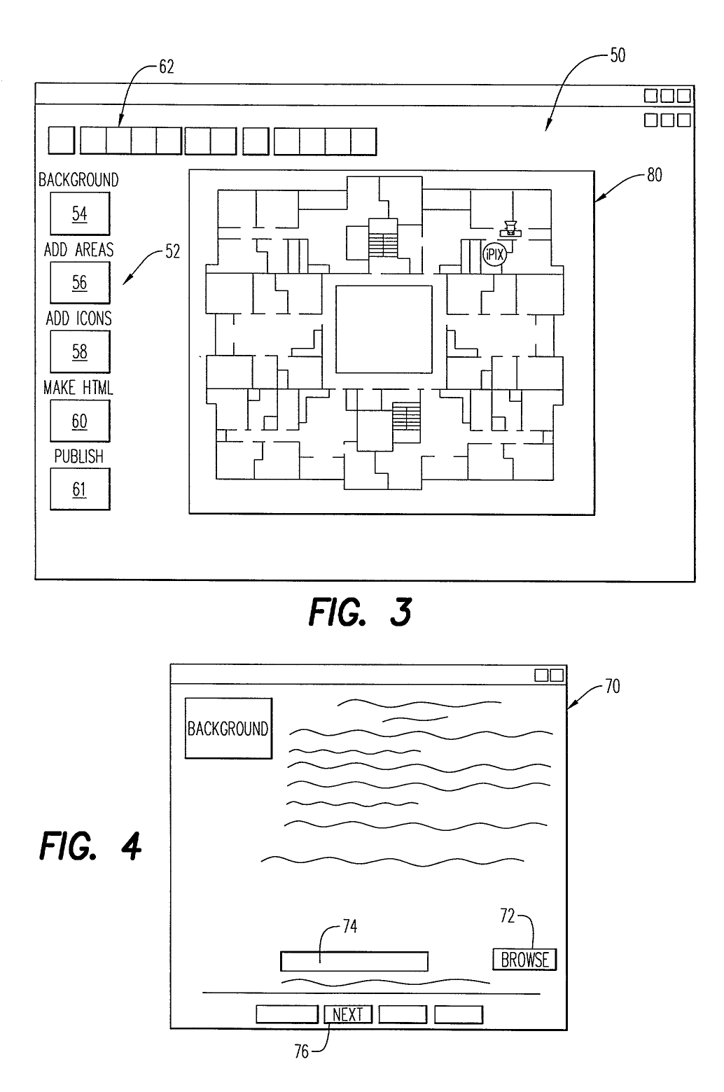

Referring to FIGS. 2 and 3, imaging program 40 will initially be described for a typical session with user device 24. A screen (e.g., a display screen) 50 is presented to user device 24. Screen 50 includes a set of selectors 52. Selectors 52 include a background selector 54, an add areas selector 56, an add icons selector 58, a make HTML (“hypertext mark up language”) selector 60 and a publish selector 61. To begin, a developer operates user device 24 to select background selector 54, which causes a screen or dialog box 70 to be presented as shown in FIG. 4.

Referring to FIG. 4, dialog box 70 allows user device 24 to select or identify an image as a digital background. Dialog box 70 includes a browse selector 72 that enables user device 24 to browse for an image file containing a desired image. For example, the image file may be contained in memory internal to user device 24, set of files 25 or at one of web sites 26 of FIG. 1. When selected by the user, the location of the image file will be presented in display area 74 and a next button 76 will be enabled. Activation of next button 76 will then cause imaging program 40 to import the selected image file for storage in database memory 36. It will be apparent to those skilled in the art that dialog boxes 62 and 70 could alternatively be screens or web pages that are presented based on a selection from screen 50 or another screen.

The image may be of any object, real or imagined. For example, the image may be a building, map, landscape, human, animal, aquatic or other body, crime or other scene, and the like. The data file for the image can be in any suitable form such as a raster, vector, jpeg, or other form, known currently or in the future.

Referring again to FIG. 3, by way of example, an image 80 of a building floor plan is shown on screen 50. That is, user device 24 identified image 80 and its location via dialog box 70 of FIG. 4. Imaging program 40 then accesses the data file for image 80 and presents image 80 on screen 50. Image 80, for example, may be a scanned raster image that has a series of dots on a white background. Each dot can be thought of as being a small square, which can be represented by the numerical coordinates of each of the square's corner points. Because the dot is thought of as a square, only the coordinates of the lower left and upper right hand corners are necessary. Image 80 serves as the background of a spatially referenced multimedia database that is being developed.

The coordinate system for the image is selectable by the developer. For example, the coordinate systems may include a rectangular system (x-y or x-y-z), a Cartesian system, a polar system, the geographical global system and like. The coordinate system for a CAD image is determined by the developer by means of a coordinate system utility in the CAD system upon which the image is created. The coordinate system for a scanned raster image, such as image 80, is an x-y system by default. However, the developer can change the default x-y system to any other system by operation of the tools button 62.

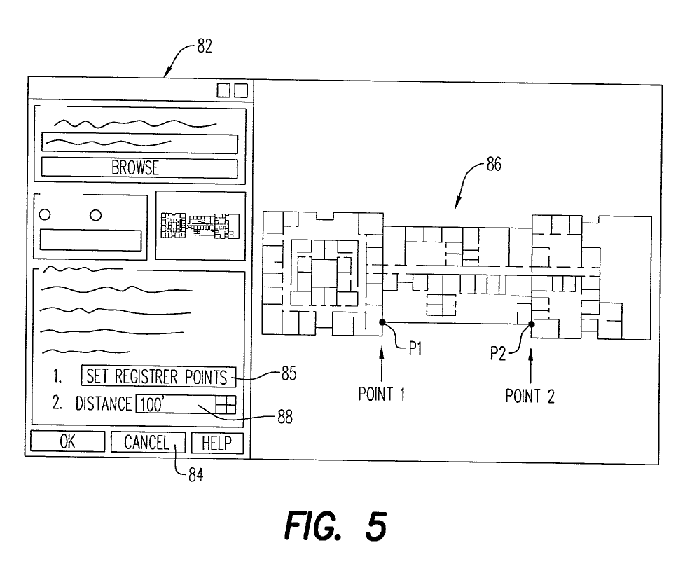

Referring to FIG. 5, the developer is presented with a dialog box 82 that gives an option to scale or not scale the image. The developer can choose not to scale by selecting a cancel button 84, in which case imaging program 40 assigns a default image. The developer can choose to scale by positioning two connected pointers point 1 and point 2, to a pair of desired points P1 and P2 on an image 86 by operation of a positioning device, such as a mouse. The image 86 is an entirely different image than image 80 of FIG. 3, but illustrates the scaling procedure that can be used with any image, such as images 80 or 86. The developer then enters in a box 88 a distance and units that represents the scaled distance between points P1 and P2. The developer then selects a set register points button 85 to register the scaling entries and proceed to the next step.

When a project for an image 80 is initially created, imaging program 40 establishes a project data folder and a CAD folder. The CAD folder contains the CAD file, which is a series of vector equations that described the geometry of the image, including any markers or placeholders. The data folder is dynamic as it expands to incorporate all data placed by the developer in or on image 80.

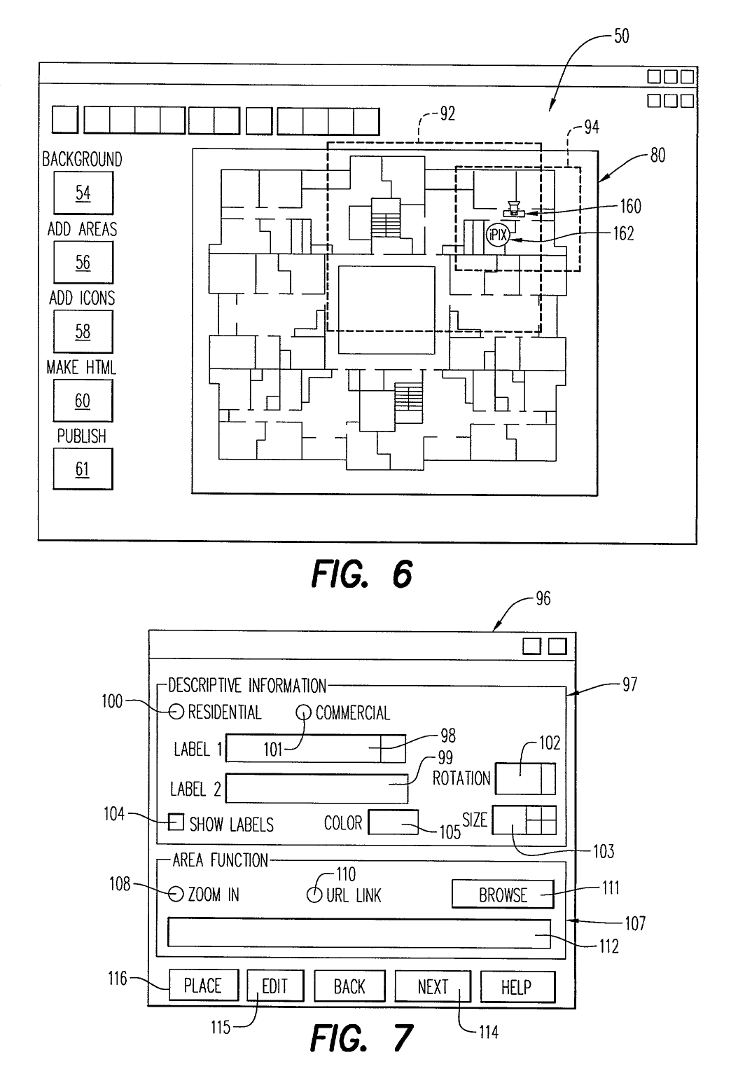

Referring to FIGS. 3 and 6, after selection of a coordinate system, image 80 and scaling, the developer operates user device 24 to activate add areas selector 56, which enables selection of one or more spatial entities or parts of image 80. The selected parts may be either entirely separate or overlapping. By way of example, overlapping spatial parts 92 and 94 are shown in FIG. 6. User device 24 selects a part by operating a device such as a mouse, keyboard or other device. For example, a mouse can be used to click on a point and drag to define an area as by any suitable geometric drawing program. Spatial parts 92 and 94 are shown as defined by rectangles, but could be defined by other geometric figures, such as circles, triangles, or other multiple sided figures. Imaging program 40 records the coordinates of selected spatial parts 92 and 94 and establishes a file for each spatial part 92 and 94. These coordinates establish the coordinates of all elements contained within spatial parts 92 or 94. Any element that appears within the coordinates that bound spatial part 92 is deemed a part thereof. Any element that appears within the coordinates that bound spatial part 94 is deemed a part thereof. Elements that appear in both spatial parts 92 and 94 are considered to be part of both. For example, a bedroom 93 appears in both spatial parts 92 and 94.

Referring to FIG. 7, imaging program 40 presents a dialog box 96 to user device 24 for selection of various attributes of spatial parts 92 and/or 94. Dialog box 96 includes a descriptive information area 97 and a function area 107. Descriptive information area 97 includes label areas 98 and 99, residential and commercial areas 100 and 101, a rotation area 102, a show labels area 104 and a color area 105. The user uses label areas 98 and/or 99 to identify a name for a selected spatial part and residential and commercial areas 100 and 101 to identify whether the building image is residential or commercial. Show labels area 104 is used to designate whether the labels are to be displayed on or in association with the spatial part. Rotation area 102 is used to designate angular orientation of the label. Size area 103 is used to designate font size for any text for the labels.

Function area 107 includes a zoom in area 108 and a URL link area 110. Selection of zoom in area 108 instructs imaging program 40 that the spatial part is to be a zoom in image when presented through browser script to the end user. Selection of URL link area 110 instructs imaging program 40 that the spatial part is to be presented to the end user from the URL address when the end user clicks on the spatial part. The URL address is entered in a URL address area 112. Activation of a next button 112 instructs imaging program 40 to record the information entered in dialog box 96.

Imaging program 40 creates a data folder for each spatial part 92 and 94. Each of these data folders is part of the project folder for image 80. With respect to the FIG. 7 dialog box, imaging program 40 will activate graphical responses when an end user selects either the recorded zoom in or the URL link area. Thus, end user selection of the zoom in will cause a zoom in or enlarged view to appear, while end user selection of the URL link area will cause a web site designated by the URL address to appear.

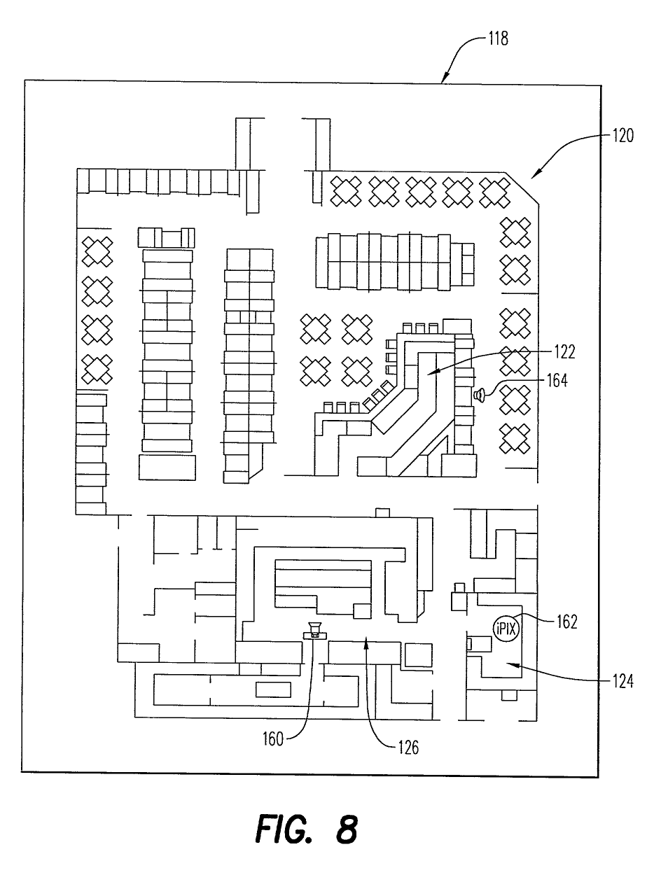

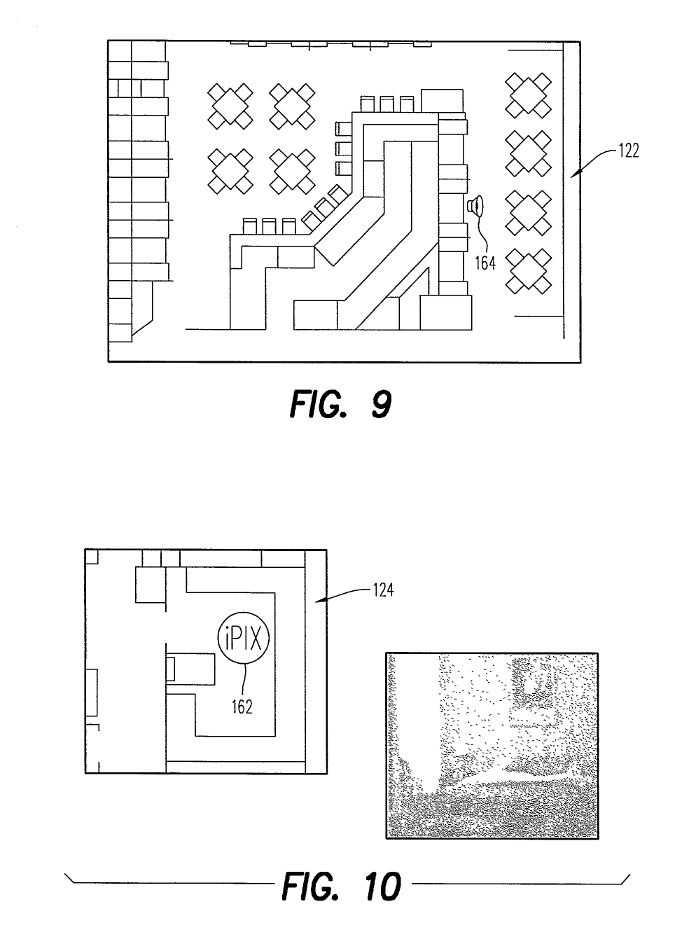

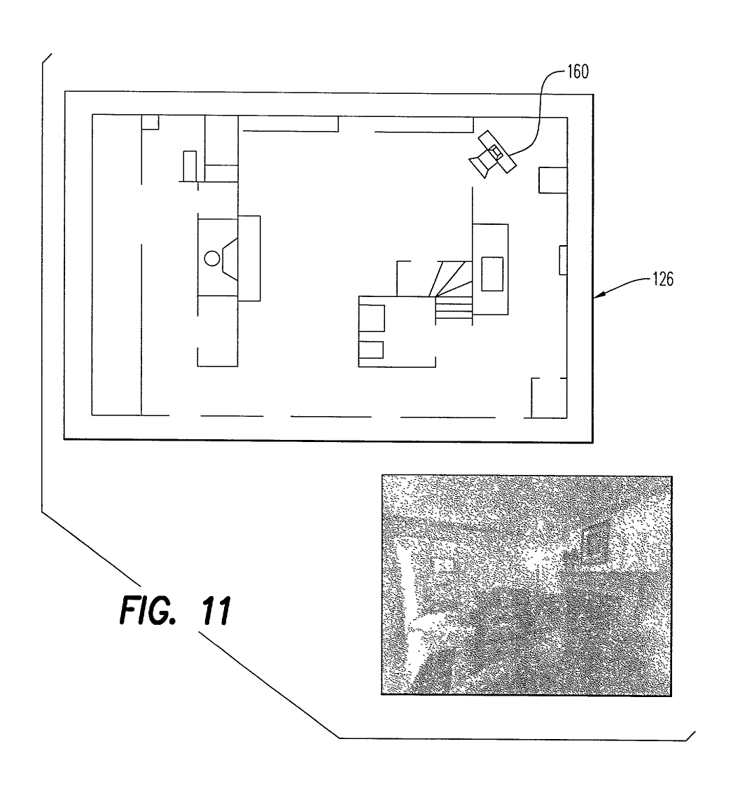

Referring to FIG. 8, an image 120 of a floor plan of another building is shown on a screen 118. That is, the developer identifies image 120 and its location via dialog box 70 of FIG. 4. Like image 80, image 120 may be a scanned raster image. The developer then selects spatial parts 122, 124 and 126. Referring to the zoom in view of FIG. 9, spatial part 122 is a bar. Referring to the zoom in view of FIG. 10, spatial part 124 is a bedroom. Referring to the zoom in view of FIG. 11, spatial part 126 is a lounge.

After spatial parts 92 and 94 (FIG. 6) or 122,124 and 126 (FIG. 8) have been selected, user device 24 is enabled to identify elements contained therein and files that describe those elements. Broadly, an element may be an event, a condition, an entity or any item that relates to a selected spatial part. For the floor plan example, an element may be an item of furniture, fixture, equipment or other item that may be found in the selected spatial parts.

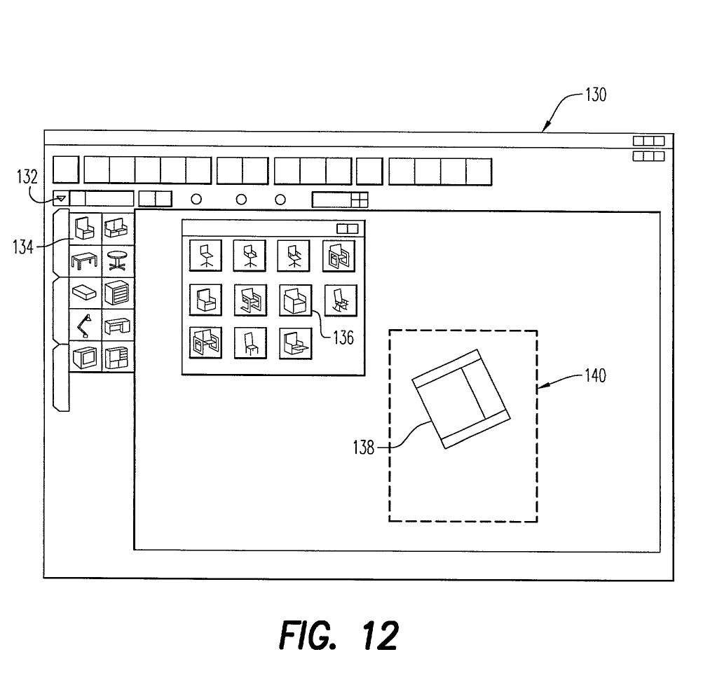

Referring to FIG. 12, a screen 130 enables the developer to identify elements, their locations and orientations in a spatial part. Imaging program 40 includes a plurality of libraries of various elements, including furniture, such as that shown in FIG. 11 for spatial part 126. The developer can select the furniture library by operation of a scroll button 132. Clicking on a chair button 134 displays a group of different types of chairs from which to select. Clicking and dragging a button 136 to a desired point on an outline 140 of spatial part 126 displays an image 138 of a chair. The developer can rotate image 138 by using arrows on the developer's keyboard (not shown) and/or the right and left click buttons on the developer's mouse (not shown). For example, the left arrow rotates image 138 clockwise in increments of 2° and the right arrow rotates image 138 counterclockwise in increments of 2° . The up arrow rotates the image 136 clockwise in increments of 90°. The down arrow rotates image counterclockwise in increments of 90°.

The developer can align image 138 by operating a mouse with a left click thereon. This action highlights image 138 and permits the developer to drag it to any desired location on the image background. Image program 40 reads the location of the newly positioned image 138 and registers the location in the database that has been defined for the location in which the image 138 has been placed. For example, image 138 may be placed in lounge spatial part 126 (FIG. 11). If no areas (spatial parts) have been assigned for the location, image program 40 simply assigns image 138 to a single master database created when image program was initiated.

The developer can highlight right image 138 by clicking thereon. This causes a dialog box (not shown) to appear, which enables the developer to change the color of the chair, to make a copy of the chair and to reposition the copy of the chair. This dialog box can also have the capability of a copy dialog for creating arrays of image 138 and of a nudge function that permits movement of image 138 in very slight increments by operation of the arrows of the developer's keyboard (not shown). Imaging program 40 counts and records all elements that appear in a spatial part.

Image program 40 has the capability for the developer to use various forms of multimedia to present image 80 of FIG. 6 or image 120 of FIG. 8, their respective spatial parts and elements. For example, the multimedia forms can include audio, video, photography, alphanumeric text and the like. Image program 40 instructs the developer to separate element files by file type.

The developer can place icons representative of desired multimedia forms at any location in image 80 or image 120 by actuating add icons selector 58. For example, as best seen in FIG. 11, a camera icon 160 that represents a photograph is shown in lounge 126. As best seen in FIG. 10, an IPIX icon 162 that represents a 360° immersion image is shown in bedroom 124. As best seen in FIG. 9, a speaker icon 164 that represents an audio presentation is shown in bar 122. The developer places these icons within spatial parts 122, 124 and 126 by operation of a keyboard or a mouse.

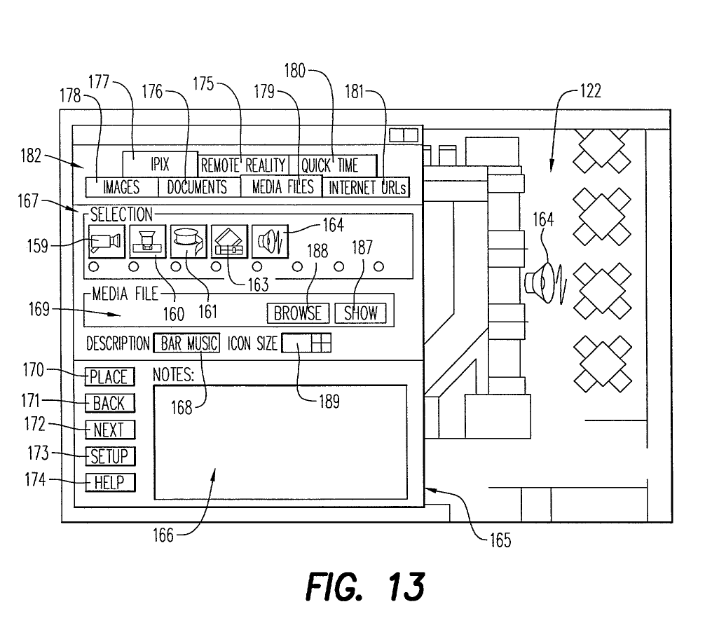

Referring to FIG. 13, actuation of add icons selector 58 (FIGS. 3 and 7) causes a drop down box 165 to be presented to the developer. Drop down box 165 includes a note pad area 166, a select icon area 167, a browse button 188, a description box 168, a place button 170, a back button 171, a next button 172, a setup button 173 (used only for URL icons) and a help button 174. A file type selection area 182 includes a remote reality tab 175, a documents tab 176, an IPIX tab 177, an images tab 178, a media tab 179, a quick time tab 180 and an Internet URLs tab 181. Selection of any of tabs 175 through 181 opens icon select menu 167 and cause image program 40 to associate script data that is necessary for writing HTML script with associated file types.

When the developer selects media files tab 179, a set of media icons is presented in select icon area 167. The media icon set includes a video camera icon 159, a camera icon 160, a tape icon 161, a film icon 163, and a speaker icon 164. Video camera icon 159, tape icon 161 and film icon 163 each associate a wide range of file scripts appropriate for launching and viewing video files on the Internet. Although video camera icon 159, tape icon 161 and film icon 163 can launch the same wide set of video files, it is useful for the developer to use separate icons to designate the different associate file types. Video file types can vary in compression affecting Internet download times) and image quality. Camera icon 160 associates a wide range of file scripts appropriate for launching and viewing image files on the Internet. Speaker icon 164 associates a wide range of file scripts appropriate for launching and playing audio files on the Internet.

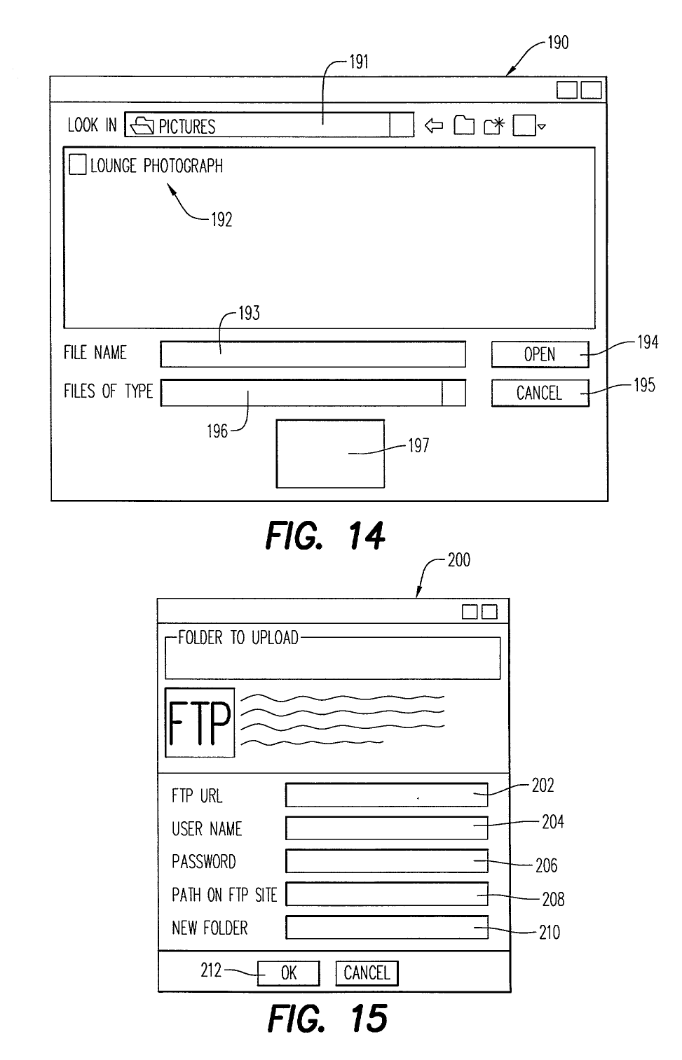

Referring to FIGS. 13 and 14, when the developer actuates browse button 188 (FIG. 13), a browse window 190 (FIG. 14) is opened. From browse window 190, the developer can look in folders that are displayed in a folder display area 191 and a view file details area 192. By selecting an open button 194, the developer can select a file to be associated with a selected one of icons 159, 160, 162, 163 and 164. Once selected and opened, the file name is displayed in a file display area 193. For the case of finding a photograph file to associate with camera icon 160 in lounge 126, the developer looks in a pictures folder that is presented in folder display area 191. A file type area 196 displays files of specific types to be displayed for browsing purposes. For the example of FIG. 14, only a lounge photograph file meets the criteria displayed in file type area 196 and resides in the folder that is displayed in folder display area 191. The lounge photograph file can be opened by actuation of an open button 194. While a folder may contain many different file types, dialog box 190 will display only files of the type displayed in file type area 196. The file types menu contains a variety of file types that may be selected.

If the developer decides to open a file that is an image file, a small screen version of the image, known as a thumbnail image, is displayed in a display box 197. If the developer does not like the image, he can close the operation by actuating a cancel button 195. The developer can then return to browsing for a file he wants to associate with a selected icon 159, 160, 162, 163 or 164 (FIG. 13). Once a file has been selected, the developer can select an appropriate icon and decide a size therefor by using a dialog box 189 in FIG. 13.

Referring again to FIG. 13, when a media file, such as the lounge photograph, has been selected, its label or identity will be displayed in a media file box 169. The developer can then actuate a show button 187 to cause a full screen image of the lounge photograph to appear. If the selected icon and file is a sound recording or a video recording, the recording will be played for the developer.

Imaging program 40 records the elements and media icons selected by the developer as overlays for the image in the appropriate spatial part data folder of the image project folder. Imaging program 40 also links the files of the media expressions to these spatial part data folders.

After the icons have been selected and placed and the associated media files have been located, activation of make HTML selector of FIG. 3, causes imaging program 40 to automatically write the script necessary to launch web pages appropriate for a browser or other device that enables an end user device to access the image based application being created. For example, browsers of different vendors may require different script to access the web pages. These web pages correspond to the image, its spatial parts, its elements and all display pages necessary for loading, viewing or interacting with embedded media types.

Imaging program 40 then saves the HTML script to the appropriate spatial part data folder of the project folder. The project folder then includes all files created for an image, its spatial parts, elements thereof, multimedia data types and any script associated with the multimedia data types. Thus, all of the files for an image are bundled into a single project folder. The project folder can then be used offline without posting to the Web.

When publish selector 61 (FIGS. 3 and 6) is actuated, image program 40 creates an HTML page that can be viewed with a browser. For example, this initial HTML page contains the created image 120, scaled close-up views of designated spatial parts 122,124 and 126 and all icons associated therewith. Imaging program 40 also creates a cascading set of web pages with the initial web page being screen 118 (FIG. 8), for example. For this example, the set of cascading web pages has three branches. If spatial part 122 is selected by the end user, a first branch includes bar zoom in view of FIG. 9 and an associated audio presentation if speaker icon 164 is selected by the end user. If spatial part 124 is selected by the end user, a second branch includes bedroom zoom in view of FIG. 10 and a 360° immersion image thereof if the ipix icon 162 is selected. If spatial part 126 is selected a third branch includes the lounge floor plan zoom in view of FIG. 11 and a photo image thereof if camera icon 160 is selected. These pages include script, which was placed in the project folder and located using an icon. By clicking on the icon, the underlying application is opened and displayed within a new web page.

Imaging program 40 creates a primary index page of maps, floor plans and areas by selecting key files of the image and selected spatial parts. The index page may include reduced size or thumbnail images of each web page. Imaging program 40 organizes the files in several ways, using:

1) a drop down menu of index pages,

2) a drop down menu of file types, and/or

3) a drill down or zoom in presentation.

Imaging program 40 optimizes the background template display. If a vector background is used, imaging program 40 retains a crisp and clean image for display on the Internet or Web. Imaging program 40 embeds script in every page that has an icon. Imaging program 40 also recognizes embedded URLs. The necessary scripting is tailored to the end user's computer browser for display via the Internet or Web. Imaging program 40 queries the end user's computer to determine what code is required.

Imaging program 40 saves the end user's name and password, server protocols and architecture for File Transfer Protocol up load and queries an upload server for existing file names. Alternatively, the file can be stored on media for direct retrieval by end users.

Referring to FIGS. 3 and 15, when the development project is ready for publication, the developer activates publish selector 61 of FIG. 3. This causes a screen or dialog box 200 to be presented to the developer. Dialog box 200 allows the developer to up load web pages directly to an Internet server. Imaging program 40 includes a file transfer protocol utility that, when properly configured, will transfer the entire set of web pages to an Internet server. Dialog box 200 includes a FTP URL area 202, a user name area 204, a password area 206, a path on FTP Site area and a new folder area 210. When all of these areas are properly filled in and the user name and password are authorized, activation of an upload button 212 will cause imaging program 40 to transfer the folder to the URL address in FTP URL area 202.

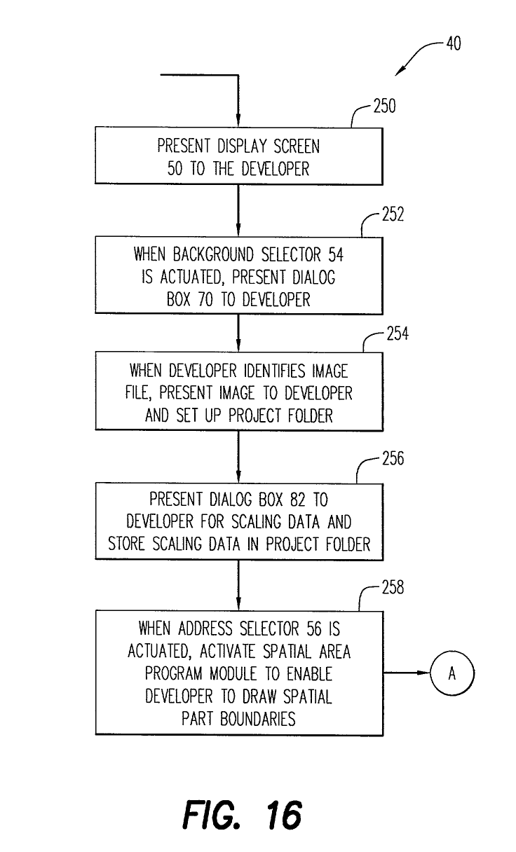

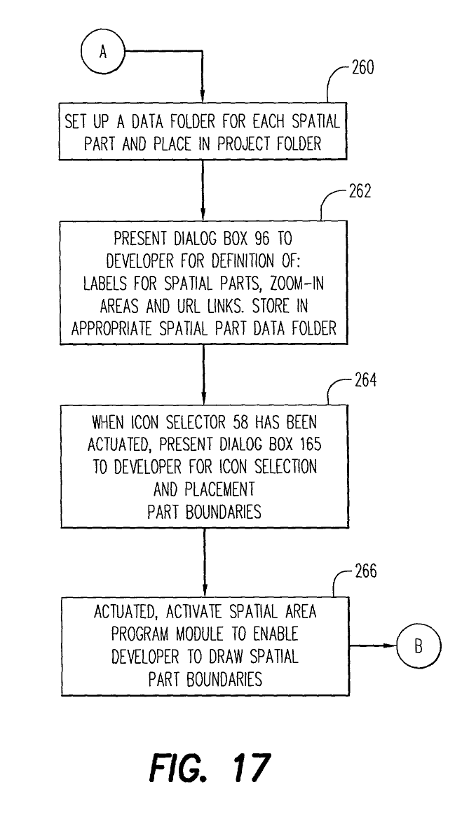

Referring to FIGS. 3 and 16, imaging program 40 begins at step 250 by presenting display screen 50 (FIG. 3) to the developer. Step 252 upon activation of the background selector 54 presents dialog box 70 to the developer for selection of an image. When the developer identifies an image file, step 254 presents the image to the developer and sets up a project file. Step 256 presents dialog box 82 to the developer to provide scaling data for the image and stores the scaling data in the project folder. When add areas selector 56 has been activated, step 258 activates a spatial parts area program module that enables the developer to draw the spatial part boundaries on the image. Imaging program 40 then continues to point A of FIG. 17.

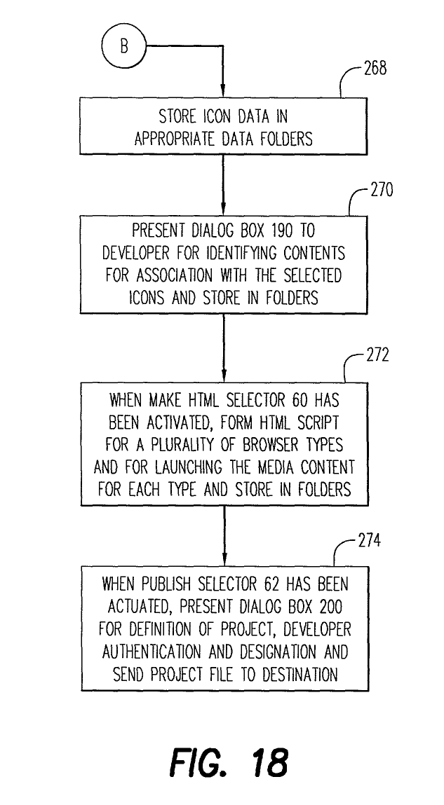

Referring to FIG. 17, step 260 sets up a data folder for each spatial part and places it in the project folder. Step 262 presents dialog box 96 to the developer for definition of labels for the spatial parts, zoom in areas and URL links. The data is stored in the appropriate spatial part folder. Step 264 presents dialog screen 130 for element registration in areas of the spatial parts. Step 264 also stores the data for the elements, their locations and orientations in the appropriate spatial parts folders. When icon selector 58 has been activated, step 266 presents dialog box 165 to the developer for icon selection and placement. Imaging program then continues at point B of FIG. 18.

Referring to FIG. 18, step 268 stores the icon data in the appropriate spatial part folders. Step 270 presents dialog box 190 to the developer for identification of the contents for association with the selected icons. Step 272 then stores the contents in the appropriate spatial parts folders. When publish selector 62 has been actuated, step 274 presents dialog box 200 to the developer for identification of the project and of the destination where the project folder is to be sent, and for developer authentication. If the developer is authenticated, step 274 then sends the project file to the destination.

The present invention having been thus described with particular reference to the preferred forms thereof, it will be obvious that various changes and modifications may be made therein without departing from the spirit and scope of the present invention as defined in the appended claims.

What is claimed is:

1. A method for developing a presentation of an image with a plurality of cascading web pages, said method comprising:
(a) registering one or more elements that are in selected areas of said image;
(b) registering one or more icons in a first one of said selected areas, wherein each of said icons is representative of a type of media;
(c) associating with a first one of said icons a content that is expressive in the media type of said first icon; and
(d) forming said plurality of cascaded web pages with HTML script that is compatible with a plurality of different types of browsers, whereby said content is presented when said first icon is selected during said presentation.

2. The method of claim 1, further comprising:
(e) scaling said image and said elements so that a scale of said elements is proportionate to a scale of said image.

3. The method of claim 1, further comprising:
(f) bundling data for said image, said elements, said icons and said content into a project folder; and
(g) presenting said folder to a server or other computing device.

4. The method of claim 1, wherein said selected areas are located in first and second spatial parts of said image.

5. The method of claim 4, wherein said first and second spatial parts overlap at least in part, and wherein one of said selected areas is located in both of said first and second spatial parts.

6. The method of claim 1, wherein steps (a), (b) and (c) are performed in an interactive session with a developer, and wherein a plurality of icons is presented to the developer for a selection of said one or more icons.

7. The method of claim 6, wherein a plurality of elements is presented to the developer for a selection of said one or more elements.

8. The method of claim 1, wherein steps (a), (b) and (c) are performed in an interactive session with a developer, and wherein said developer is given the option to define any of said areas as a zoom in area.

9. The method of claim 1, wherein steps (a), (b) and (c) are performed in an interactive session with a developer, and wherein said developer is given the option to define any of said areas or any of said elements with a URL address, and wherein step (d) forms said pages with said URL address embedded on any of said pages containing an area with said URL address.

10. A method for developing a presentation of an image with a plurality of cascading pages, said method comprising:
(a) conducting an interactive session with a developer of said presentation by:
(a1) registering one or more elements at selected areas of said image;
(a2) registering one or more icons in a first one of said selected areas, wherein each of said icons is representative of a type of media;
(a3) associating with a first one of said icons a content that is expressive in the media type of said first icon; and
(a4) scaling said image and said elements so that a scale of said image proportionate to a scale of said image; and
(b) forming said plurality of cascaded web pages with HTML script that is compatible with a plurality of different types of browsers, whereby said content is presented when said first icon is selected during said presentation.

11. The method of claim 10, wherein said selected areas are located in first and second spatial parts of said image.

12. The method of claim 11, wherein said first and second spatial parts overlap at least in part, and wherein one of said selected areas is located in both of said first and second spatial parts.

13. The method of claim 10, wherein a plurality of icons is presented to the developer for a selection of said one or more icons.

14. The method of claim 10, wherein a plurality of elements is presented to the developer for a selection of said one or more elements.

15. The method of claim 10, wherein said developer is given the option to define any of said selected areas as a zoom in area.

16. The method of claim 15, wherein said developer is given the option to define any of said selected areas or any of said elements with a URL address, and wherein step (b) forms said pages with said URL address embedded on any of said pages containing any of said selected areas with said URL address.

17. A computer apparatus for developing a presentation of an image with a plurality of web pages, said computer apparatus comprising:
first means for conducting an interactive session with a developer of said presentation by performing the operations of:
(a) registering one or more elements at selected areas of said image;
(b) registering one or more icons in a first one of said areas, wherein each of said icons is representative of a type of media;
(c) associating with a first one of said icons a content that is expressive in the media type of said first icon; and
(d) scaling said image and said elements so that a scale of said image proportionate to a scale of said image; and
second means for forming said plurality of cascaded web pages with HTML script that is compatible with a plurality of different types of browsers, whereby said content is presented when said first icon is selected during said presentation.
